(19) United States
(12) Patent Application Publication
(10) Pub. No.: US 2007/0183533 A1
(43) Pub. Date: Aug. 9, 2007

(54) MIMO system with spatial diversity

(76) Inventors: Timothy M. Schmidl, Dallas, TX (US); Eko N. Onggosanusi, Allen, TX (US); Anand G. Dabak, Plano, TX (US)

Correspondence Address: TEXAS INSTRUMENTS INCORPORATED, P O BOX 655474, M/S 3999, DALLAS, TX, 75265, US

(21) Appl. No.: 11/704,495

(22) Filed: Feb. 8, 2007

Related U.S. Application Data
(60) Provisional application No. 60/771,292, filed on Feb. 8, 2006.

(51) Int. Cl. H04L 27/00; H04L 1/02

(52) U.S. Cl. 375/299; 375/267; 375/347

(57) ABSTRACT

A method of transmitting a wireless signal (FIGS. 2 and 3A) is disclosed. A data stream (DATA) is received at a first transmitter (210). The data stream is also received by a second transmitter (214) that is remote from the first transmitter. The first transmitter (210) transmits a first part (S1) of the data stream to a remote receiver (220). The second transmitter (214) transmits a second part (S2) of the data stream to the remote receiver (220). The second transmitter (214) is remote from the first transmitter (210).

### CROSS-REFERENCES TO RELATED APPLICATIONS

This application claims the benefit, under 35 U.S.C. §119(e) (1), of U.S. Provisional Application No. 60/771,292 (TI-60224PS1), filed Feb. 8, 2006, and incorporated herein by this reference.

### BACKGROUND OF THE INVENTION

The present embodiments relate to wireless communication systems and, more particularly, to Multiple-input Multiple-output (MIMO) communication systems having spatial diversity.

Wireless communications are prevalent in business, personal, and other applications, and as a result the technology for such communications continues to advance in various areas. One such advancement includes the use of spread spectrum communications, including that of code division multiple access (CDMA) which includes wideband code division multiple access (WCDMA) cellular communications. In CDMA communications, user equipment (UE) (e.g., a hand held cellular phone, personal digital assistant, or other) communicates with a base station, where typically the base station corresponds to a “cell.” CDMA communications are by way of transmitting symbols from a transmitter to a receiver, and the symbols are modulated using a spreading code which consists of a series of binary pulses. The code runs at a higher rate than the symbol rate and determines the actual transmission bandwidth. In the current industry, each piece of CDMA signal transmitted according to this code is said to be a “chip,” where each chip corresponds to an element in the CDMA code. Thus, the chip frequency defines the rate of the CDMA code. WCDMA includes alternative methods of data transfer, one being frequency division duplex (FDD) and another being time division duplex (TDD), where the uplink and downlink channels are asymmetric for FDD and symmetric for TDD. Another wireless standard involves time division multiple access (TDMA) apparatus, which also communicate symbols and are used by way of example in cellular systems. TDMA communications are transmitted as a group of packets in a time period, where the time period is divided into time slots so that multiple receivers may each access meaningful information during a different part of that time period. In other words, in a group of TDMA receivers, each receiver is designated a time slot in the time period, and that time slot repeats for each group of successive packets transmitted to the receiver. Accordingly, each receiver is able to identify the information intended for it by synchronizing to the group of packets and then deciphering the time slot corresponding to the given receiver. Given the preceding, CDMA transmissions are receiver-distinguished in response to codes, while TDMA transmissions are receiver-distinguished in response to time slots.

Referring to FIGS. 1A and 1B, there are wireless communication systems of the prior art. The VBLAST system of FIG. 1B uses a vertically layered space-time architecture as described by Wolniansky et al., “V-BLAST: An Architecture for Realizing Very High Data Rates Over the Rich-Scattering Wireless Channel” (ISSSE, October 1998) and by Wolniansky et al., “Detection algorithm and initial laboratory results using V-BLAST space-time communication architecture” (IEEE Vol. 35, No. 1, January 1999). The H-Blast system of FIG. 1A differs primarily in the use of a horizontally layered space-time architecture. The HBLAST circuit (FIG. 1B) includes data buffer 141, serial-to-parallel converter 110, modulation code schemes 100 (MCS 1) and 104 (MCS 2), and transmit antennas 102 and 106. These separate modulation code schemes permit different code rates for each transmit antenna. The VBLAST circuit of FIG. 1B includes data buffer 142, modulation code scheme 105 (MCS), serial-to-parallel converter 110, and transmit antennas 102 and 106.

The HBLAST and VBLAST circuits transmit the signals via respective antennas 102 and 106 to user equipment 150 and 154 within the wireless system. For example, a signal 162 from antenna 102 is transmitted to UE 1 150. Likewise, a signal 168 is transmitted from antenna 106 to UE 2 154. Antennas 102 and 106, however, also transmit respective interference signals 166 and 164. These interference signals degrade the intended data signal at the user equipment, thereby reducing a maximum data rate within the communication system.

Wireless communications are further degraded by the channel effect. For example, the transmitted signals 162 and 168 in FIGS. 1A and 1B are likely reflected by objects such as the ground, mountains, buildings, and other things that it contacts. Thus, when the transmitted communication arrives at the receiver, it has been affected by the channel effect as well as interference signals. Consequently, the originally-transmitted data is more difficult to decipher. Various approaches have been developed in an effort to reduce or remove the channel effect from the received signal so that the originally-transmitted data is properly recognized. In other words, these approaches endeavor to improve signal-to-interference+noise ratio (SINR), thereby improving other data accuracy measures (e.g., bit error rate (BER), frame error rate (FER), and symbol error rate (SER)).

One approach to improve SINR is referred to in the art as antenna diversity, which refers to using multiple antennas at the transmitter, receiver, or both. For example, in the prior art, a multiple-antenna transmitter is used to transmit the same data on each antenna where the data is manipulated in some manner differently for each antenna. One example of such an approach is space-time transmit diversity (STTD), also known as space-time block code (STBC). In STTD, a first antenna transmits a block of two input symbols over a corresponding two symbol intervals in a first order while at the same time a second antenna transmits, by way of example, the complex conjugates of the same block of two symbols and wherein those conjugates are output in a reversed order relative to how they are transmitted by the first antenna and the second symbol is a negative value relative to its value as an input.

Another approach to improve SINR combines antenna diversity with the need for higher data rate. Specifically, a Multiple-input Multiple-output (MIMO) system with transmit diversity has been devised, where each transmit antenna transmits a distinct and respective data stream. In other words, in a MIMO system, each transmit antenna transmits symbols that are independent from the symbols transmitted by any other transmit antennas for the transmitter and, thus, there is no redundancy of the transmitted signal over multiple transmit antennas. The advantage of a MIMO scheme using distinct and non-redundant streams is that it can achieve higher data rates as compared to a transmit diversity system.

Communication system performance demands in user equipment, however, are often dictated by web access. Applications such as news, stock quotes, video, and music require substantially higher performance in downlink transmission than in uplink transmission. Thus, MIMO system performance may be further improved for High-Speed Downlink Packet Access (HSDPA) by Orthogonal Frequency Division Multiplex (OFDM) transmission. With OFDM, multiple symbols are transmitted on multiple carriers that are spaced apart to provide orthogonality. An OFDM modulator typically takes data symbols into a serial-to-parallel converter, and the output of the serial-to-parallel converter is considered as frequency domain data symbols. The frequency domain tones at either edge of the band may be set to zero and are called guard tones. These guard tones allow the OFDM signal to fit into an appropriate spectral mask. Some of the frequency domain tones are set to values which will be known at the receiver, and these tones are termed pilot tones or symbols. These pilot symbols can be useful for channel estimation at the receiver. An inverse fast Fourier transform (IFFT) converts the frequency domain data symbols into a time domain waveform. The IFFT structure allows the frequency tones to be orthogonal. A cyclic prefix is formed by copying the tail samples from the time domain waveform and appending them to the front of the waveform. The time domain waveform with cyclic prefix is termed an OFDM symbol, and this OFDM symbol may be upconverted to an RF frequency and transmitted. An OFDM receiver may recover the timing and carrier frequency and then process the received samples through a fast Fourier transform (FFT). The cyclic prefix may be discarded and after the FFT, frequency domain information is recovered. The pilot symbols may be recovered to aid in channel estimation so that the data sent on the frequency tones can be recovered. A parallel-to-serial converter is applied, and the data is sent to the channel decoder. Just as with HSDPA, OFDM communications may be performed in an FDD mode or in a TDD mode.

While the preceding approaches provide steady improvements in wireless communications, the present inventors recognize that still further improvements may be made by addressing some of the drawbacks of the prior art. In particular, there is a need to improve communication quality and data rates for Broadcast and Multicast services. This is particularly important, since Broadcast and Multicast services are not retransmitted when the UE fails to receive a transmission. Moreover, Broadcast and Multicast services should be compatible with base stations having 1, 2, or 4 transmit antennas. This compatibility should include single antenna legacy transmitters in current use. This is because multiple or even all the base stations within the same network can broadcast the same or similar content. Hence, the potential gain from using multiple antennas should be exploited. Accordingly, the preferred embodiments described below are directed toward these benefits as well as improving upon the prior art.

### BRIEF SUMMARY OF THE INVENTION

In a first preferred embodiment, first and second wireless transmitters remote from each other each receive a data stream for transmission. The data stream is divided into first and second parts. The first transmitter transmits the first part of the data stream to a remote receiver. The second transmitter transmits the second part of the data stream to the remote receiver. The remote receiver combines the first part and the second part to produce the data stream.

### BRIEF DESCRIPTION OF THE SEVERAL VIEWS OF THE DRAWING

FIG. 1A is a block diagram of a HBLAST communication system of the prior art;

FIG. 1B is a block diagram of a VBLAST communication of the prior art;

FIG. 2 is a simplified diagram of a cellular network of the present invention having five cells;

FIGS. 3A-3B are block diagrams of HBLAST transmitters of the present invention;

FIGS. 3C-3D are block diagrams of VBLAST transmitters of the present invention;

FIG. 3E is a block diagram of another HBLAST transmitter of the present invention having four transmit antennas;

FIGS. 4A-4B are block diagrams of a two antenna transmitter of the present invention having transmit diversity;

FIGS. 4C-4D are block diagrams of a four antenna HBLAST transmitters of the present invention having transmit diversity;

FIG. 5A is a block diagram of a two antenna receiver of the present invention adapted for OFDM reception;

FIG. 5B is a block diagram of a four antenna receiver of the present invention adapted for OFDM reception;

FIGS. 6A-6B are tables showing embodiments of the Broadcast/Multicast transmission structure of the present invention;

FIG. 7 is a diagram of first and second parts of a Broadcast/Multicast data stream;

FIG. 8 is a table of simulation assumptions for simulations of FIGS. 12-23;

FIG. 9 is a table of modulation coding schemes for simulations of FIGS. 12-23;

FIG. 10 is a table of simulation parameters for simulations of FIGS. 12-23;

FIG. 11 is a table of simulated gain of multi-antenna schemes over single antenna transmission from simulations of FIGS. 12-23;

FIGS. 12-17 are simulations of the present invention for 1 km separation of transmitters of adjacent cells; and

FIGS. 18-23 are simulations of the present invention for 2.8 km separation of transmitters of adjacent cells.

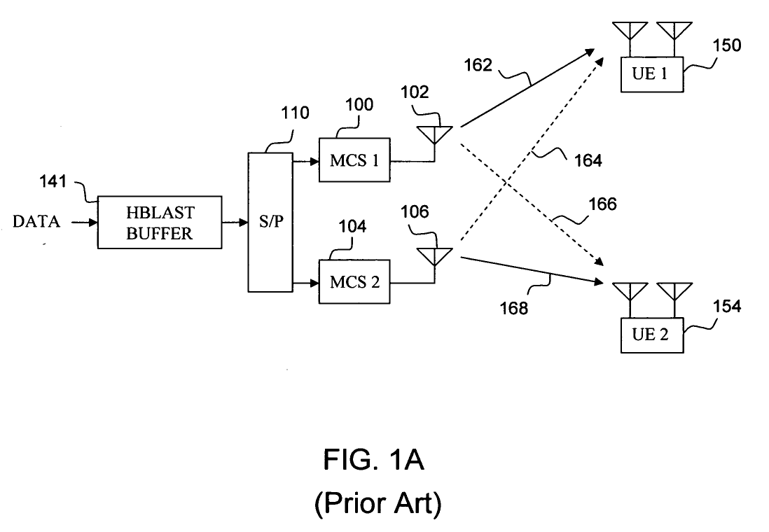

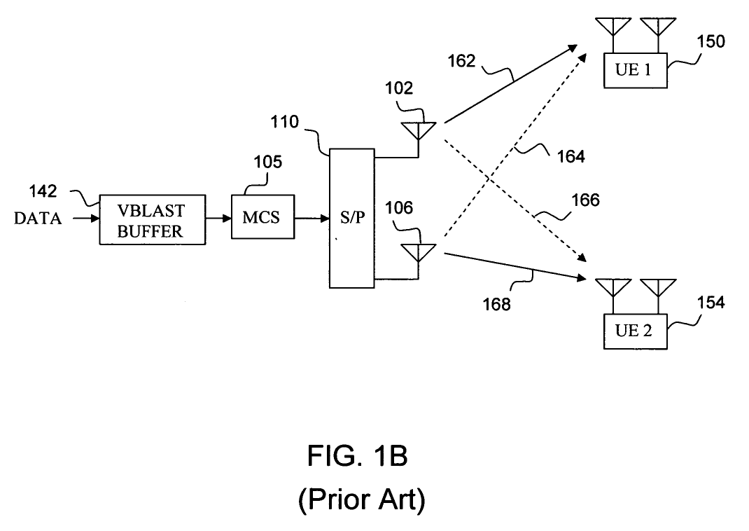

### DETAILED DESCRIPTION OF THE INVENTION

The preferred embodiments of the present invention provide improved data rates for a wireless communication system. The wireless communication system preferably provides for the Long Term Evolution (LTE) of High-Speed Downlink Packet Access (HSDPA) and Multiple-input Multiple-output (MIMO) as will be explained in detail. Common identification numerals are used in the following explanation to signify circuits having substantially the same function. Transmit antennas in the following diagrams include RF amplification circuitry as is understood by one of ordinary skill in the art.

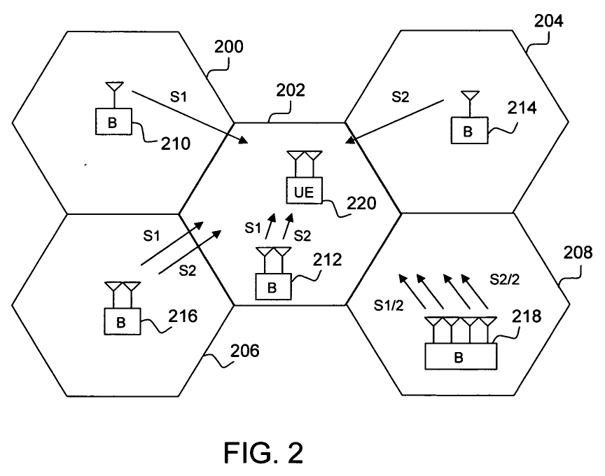

Referring to FIG. 2, there is a wireless communication network illustrating several embodiments of the present invention. The wireless communication network includes five individual cells 200-208. Each cell includes a respective base station 210-218. Each base station is remotely sited from base stations of adjacent cells by a certain distance (e.g. 1 Km to 5 Km). However, indoor base stations in shopping malls or office buildings may be separated by only a few hundred meters. Base stations 210 and 214 are single antenna legacy transmitters. Base stations 212 and 216 each have two transmit antennas. Base station 218 has four transmit antennas. Cell 202 includes user equipment (UE) 220.

In Broadcast/Multicast operation, each of the five base stations receives a data stream for transmission to UE 220. The data stream is preferably divided into a first part (S1) and a second part (S2). Note that S1 and S2 can be parts of the same data content. For example, S1 carries the base layer (such as lower resolution content of a video) while S2 carries the enhanced layer (such as higher resolution content of a video or additional side contents). This is useful for differentiation across services. This especially applies when different base stations in the network may have different number of antennas. On the other hand, it is also possible that S1 and S2 originate from complete different content sources. Base stations 212 and 216 achieve spatial diversity by transmitting the first (S1) and second (S2) parts of the data stream from their respective first and second transmit antennas. Base stations 210 and 214, however, are single antenna legacy transmitters. They achieve spatial diversity by synchronously transmitting the first part (S1) from base station 210 and the second part (S2) from base station 214. Base station 218 achieves spatial diversity by transmitting the first part (S1) of the data stream from two transmit antennas at half power (S1/2) and synchronously transmitting the second part (S2) of the data stream from each of the other two transmit antennas at half power (S2/2). In this manner, Broadcast/Multicast transmissions of first (S1) and second (S2) parts of the original data stream are received synchronously by UE 220 from the five base stations 210-218. These first (S1) and second (S2) parts are combined by MIMO processing to reproduce the original data stream. If all the base stations in the network utilize the same number of antennas, S1 and S2 can simply be the fragmentation of the same data packet.

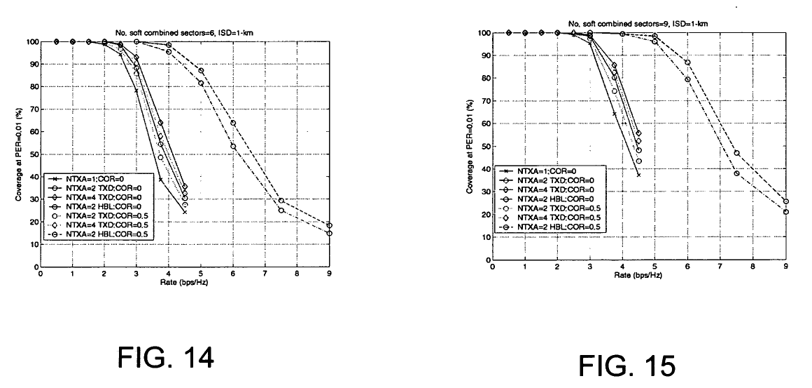

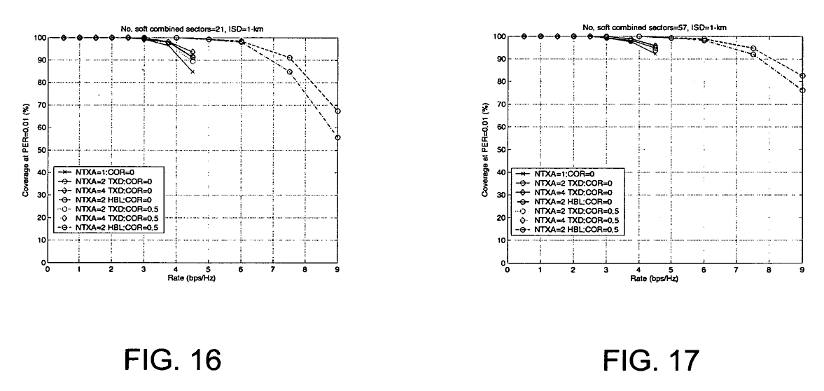

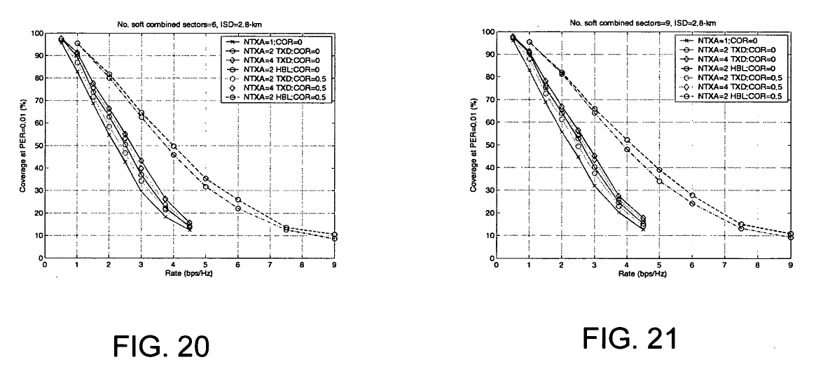

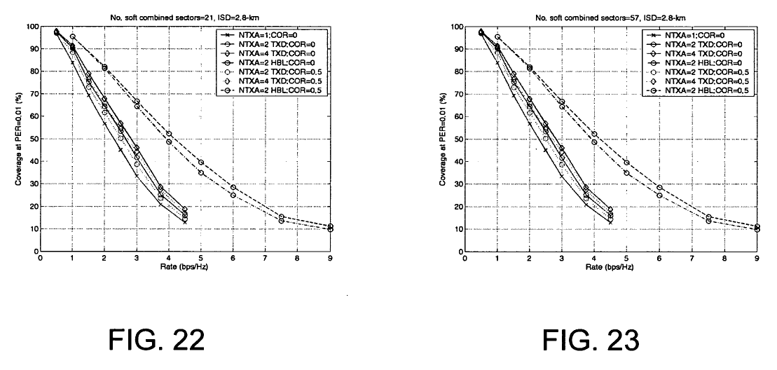

The wireless communication network of FIG. 2 greatly improves communication quality through spatial diversity as will be explained in detail with regard to the simulations of FIGS. 14-25. Data rates for Broadcast/Multicast services are improved by transmitting first and second parts of the original data stream synchronously to reduce transmit time. Modulation formats such as 16-QAM and 64-QAM further improve data rates over QPSK due to improved signal quality. Broadcast/Multicast services transmitted according to the present invention are compatible with base stations having 1, 2, 4, or more transmit antennas. This compatibility includes single antenna legacy transmitters in current use. Finally, the Broadcast and Multicast services are compatible with but not limited to multiple bandwidth channels of 1.25, 2.5, 5, 10, 15, and 20 MHz.

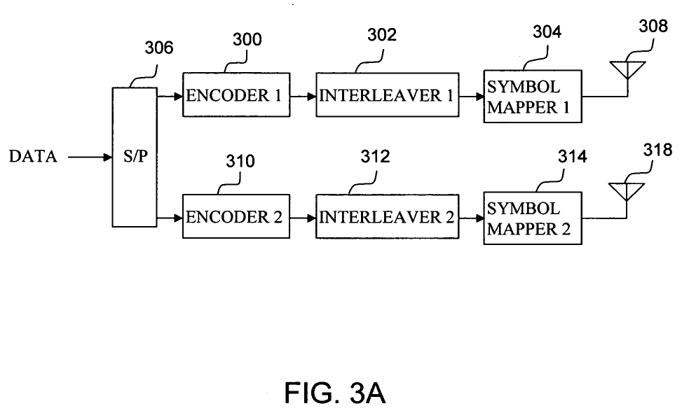

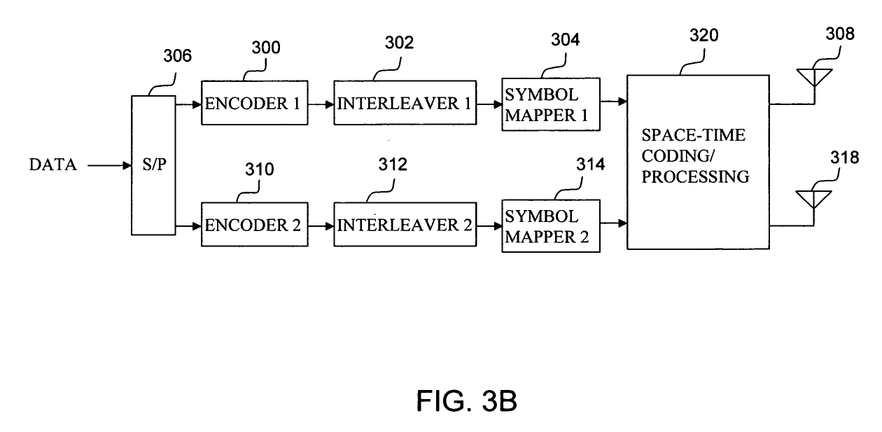

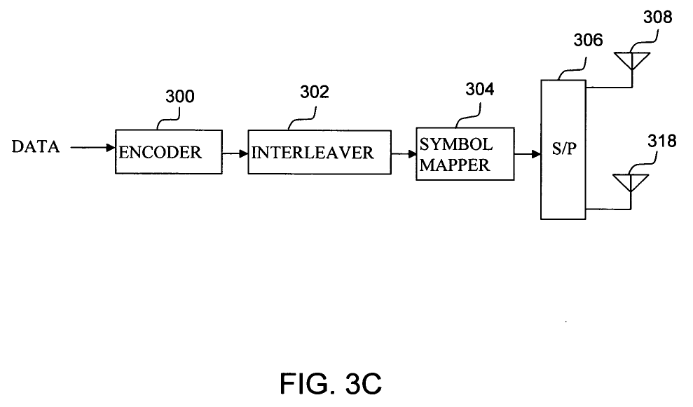

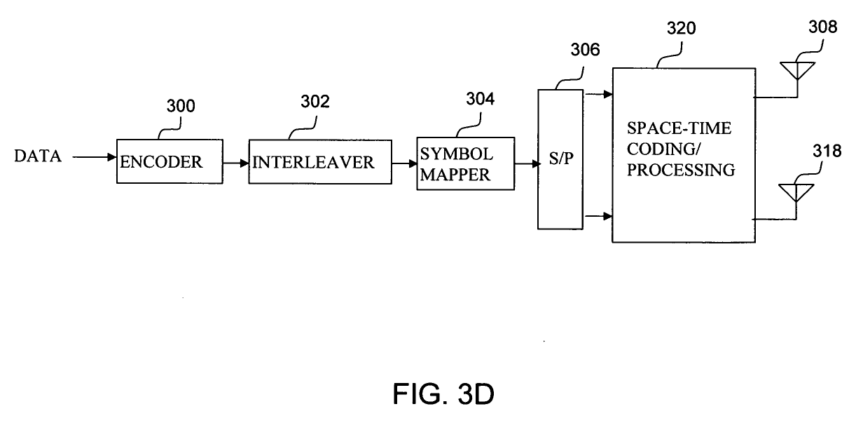

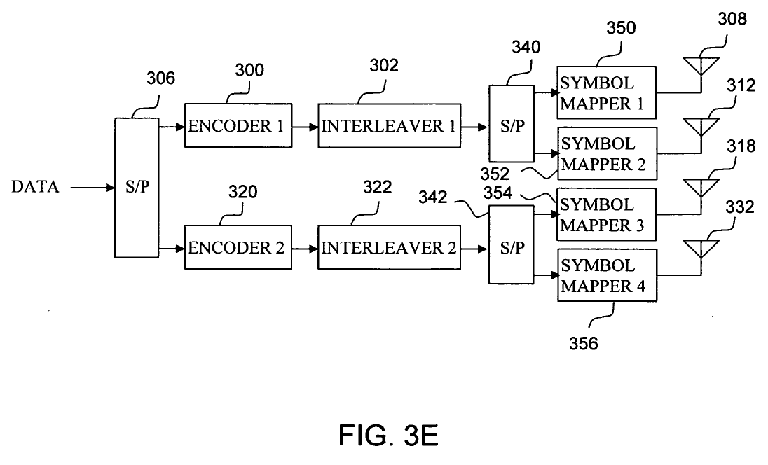

Referring now to FIG. 3A, there is a HBLAST wireless transmitter of the present invention. The transmitter receives an input data stream from a baseband processor (not shown). This data stream may include pilot signals, control signals, and data signals for synchronization and control of remote wireless user equipment (UE). The data stream is divided into first and second data streams by serial-to-parallel circuit 306. Both first and second data streams may be separately encoded based on channel quality information (CQI). The particular code may be a low density parity code, turbo code, Hamming code, Reed Solomon code, or other code as is known in the art. Moreover, the particular code may be different for each encoder 300 and 310. The CQI corresponding to each encoder 300 and 310 may be fed back from a remote UE in a previous communication. A particular code rate for each encoder is selected to reduce data errors and minimize retransmission of data. In general, a code rate of N/M indicates that N input data bits produce M encoded output data bits. In practical wireless communication systems, the code rate may vary from a very low rate (such as ⅛) for low CQI to a very high rate (such as ⅚) for high CQI. The first data stream is encoded at a first data rate by encoder 300. The second data stream is encoded at a second data rate by encoder 310. Interleavers 302 and 312 interleave their respective encoded data streams which are then applied to respective symbol mappers 304 and 314. The symbol mappers convert the interleaved data streams to respective symbol constellations. These symbol constellations may be, for example, QPSK (2 bit), 16-QAM (4 bit), or 64-QAM (6 bit). An appropriate symbol constellation is preferably selected in response to the CQI. For a low CQI, the symbol mapper may produce a QPSK symbol. Alternatively, for a high CQI, the symbol mapper may produce a 64-QAM symbol.

Data symbols from symbol mapper 304 are applied to transmit antenna 308. Likewise, data symbols from symbol mapper 314 are applied to transmit antenna 318. As previously explained with regard to base stations 212 and 216 (FIG. 2), first (S1) and second (S2) data streams are then transmitted to remote UE 220. In an alternative embodiment of the present invention, both transmit antennas (308, 318) of base station 212 may transmit the first part (S1) of the data stream at half power (S1/2). Both transmit antennas (308, 318) of base station 216 would then transmit the second part (S2) of the data stream at half power (S2/2). Either configuration of the wireless communication advantageously provides spatial diversity.

Turning now to FIG. 3B, there is an alternative embodiment of the HBLAST transmitter of FIG. 3A. In this embodiment of the HBLAST transmitter, output data streams of symbol mappers 304 and 314 are applied to space-time, space-frequency, or space-time-frequency coding block 320. The output streams of space-time block 320 are then applied to respective transmit antennas 308 and 318. The space-time or space-frequency or space-time-frequency coding operation includes any transmitter processing that permutes, shapes, applies complex conjugates, and/or transform the mapped symbols (e.g. QPSK, 16QAM, or 64QAM) to increase the robustness and diversity gain of the transmitted signal. Some examples include linear dispersion coding (in space-time or space-frequency), lattice coding such as Golden or Perfect codes, and layered/threaded space-time coding.

Referring now to FIG. 3C, there is a VBLAST wireless transmitter of the present invention. The transmitter receives an input data stream from a baseband processor (not shown). This data stream may include pilot signals, control signals, and data signals for synchronization and control of remote wireless user equipment (UE). The data stream may be encoded based on channel quality information (CQI). As previously explained, the particular code may be a low density parity code, turbo code, Hamming code, Reed Solomon code, or other code as is known in the art. A particular code rate for each encoder is selected to reduce data errors and minimize retransmission of data. Interleaver 302 interleaves the encoded data stream which is then applied to symbol mapper 304. The symbol mapper converts the interleaved data stream to a sequence of symbol constellations. These symbol constellations may be, for example, QPSK (2 bit), 16-QAM (4 bit), or 64-QAM (6 bit). An appropriate symbol constellation is preferably selected in response to the CQI. For a low CQI, the symbol mapper may produce a QPSK symbol. Alternatively, for a high CQI, the symbol mapper may produce a 64-QAM symbol. The sequence of symbols is then applied to serial-to-parallel converter 306 where it is divided into first and second parts. The first part is applied to transmit antenna 308, and the second part is applied to transmit antenna 318.

As previously explained with regard to base stations 212 and 216 (FIG. 2), first (S1) and second (S2) data streams are then transmitted to remote UE 220. In an alternative embodiment of the present invention, both transmit antennas (308, 318) of base station 212 may transmit the first part (S1) of the data stream at half power (S1/2). Both transmit antennas (308, 318) of base station 216 would then transmit the second part (S2) of the data stream at half power (S2/2). Either configuration of the wireless communication advantageously provides spatial diversity.

The embodiment of FIG. 3D is a modification of the VBLAST transmitter of FIG. 3C. In this embodiment of the VBLAST transmitter, output data streams of serial-to-parallel converter 306 are applied to space-time, space-frequency, or space-time-frequency coding block 320. The output streams of space-time, space-frequency, or space-time-frequency block 320 are then applied to respective transmit antennas 308 and 318. The space-time, space-frequency, or space-time-frequency coding operation includes any transmitter processing that permutes, shapes, applies complex conjugates, and/or transform the mapped symbols (e.g. QPSK, 16QAM, or 64QAM) to increase the robustness and diversity gain of the transmitted signal. Some examples include linear dispersion coding (in space-time or space-frequency), lattice coding such as Golden or Perfect codes, and layered/threaded space-time coding.

Referring now to FIG. 3E, there is a four antenna HBLAST wireless transmitter of the present invention. The transmitter receives an input data stream at serial-to-parallel converter 306. The input data stream is divided into two parts and applied to respective encoders 300 and 320. Both first and second data streams are separately encoded based on channel quality information (CQI). A particular code rate for each encoder is selected to reduce data errors and minimize retransmission of data. Interleavers 302 and 322 interleave their respective encoded data streams which are then applied to respective serial-to-parallel converters 340 and 342. Serial-to-parallel converter 340 produces two separate sub streams from the first part of the original input data stream. These two sub streams are applied to respective symbol mappers 350 and 352. The symbol mappers convert the interleaved data streams to respective symbol constellations which are then applied to respective transmit antennas 308 and 312. Likewise, serial-to-parallel converter 342 produces two separate sub streams from the second part of the original input data stream. These two sub streams are applied to respective symbol mappers 354 and 356. The symbol mappers convert the interleaved data streams to respective symbol constellations which are then applied to respective transmit antennas 318 and 332.

In operation, transmit antennas 308 and 312 may both transmit the same first part (S1) of the original data stream at half power (S1/2) as previously explained with regard to base station 218 (FIG. 2). Transmit antennas 318 and 332 would synchronously transmit the same second part (S2) of the original data stream at half power (S2/2). In another embodiment of the present invention, transmit antennas 308, 312, 318, and 332 might all transmit the first part (S1) of the original data stream at one fourth power. Cooperatively, both transmit antennas of base station 216 (FIG. 2) would transmit the second part (S2) of the original data stream at half power (S2/2). In yet another embodiment, each transmit antenna (308, 312, 318, 332) might synchronously transmit one fourth of the original data stream to a remote four antenna UE. The foregoing embodiments as well as numerous other embodiments advantageously provide spatial diversity of the present invention.

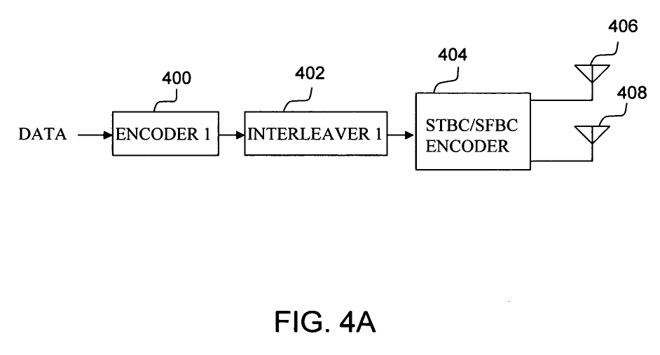

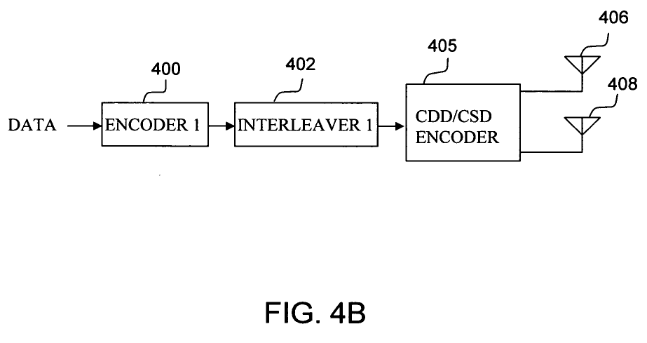

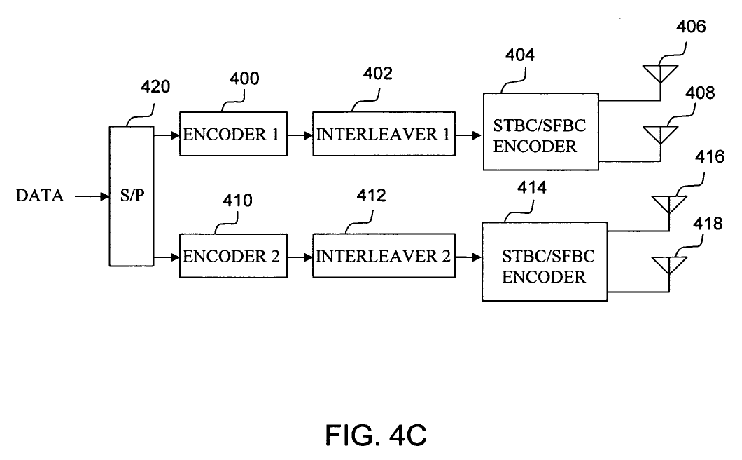

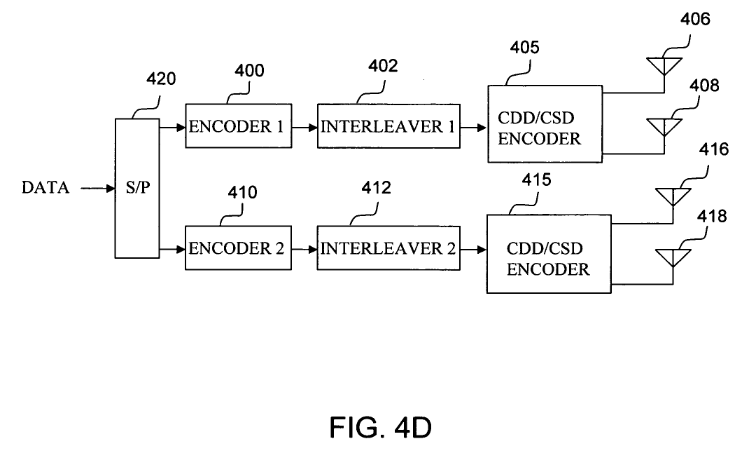

Turning now to FIGS. 4A-4B there are embodiments of a two antenna transmitter of the present invention. Both encoder 400 and interleaver 402 function as previously explained. The interleaved data stream of FIG. 4A, however, is applied to space-time, space-frequency, or space-time-frequency encoder 404. In FIGS. 4A-4B, space-time block coder (STBC) and space-frequency block coder (SFBC) are used as examples although, this applies to and space-time, space-frequency, or space-time-frequency coding. The output data streams are subsequently applied to respective transmit antennas 406 and 408. The embodiment of FIG. 4B is similar to the embodiment of FIG. 4A, except encoder 404 is replaced by encoder 405. Encoder 405 is preferably a cyclic delay diversity (CDD) coder or a cyclic shift diversity (CSD) coder. Both embodiments advantageously provide spatial diversity as previously described with regard to the embodiments of FIGS. 3A-3D.

Referring now to FIGS. 4C-4D, there are four antenna embodiments of HBLAST transmitters of the present invention corresponding to previously described two antenna embodiments of FIGS. 4A-4B, respectively. Each transmitter receives an input data stream at serial-to-parallel converter 420. The input data stream is divided into two parts and applied to respective encoders 400 and 410. Both first and second data streams are separately encoded based on channel quality information (CQI). A particular code rate for each encoder is selected to reduce data errors and minimize retransmission of data. Interleavers 402 and 412 interleave their respective encoded data streams which are then applied to respective space-time, space-frequency, or space-time, frequency encoders. In FIG. 4C, the space-time block coders (STBC) and space-frequency block coders (SFBC) are used as examples although this applies to any space-time, space-frequency, or space-time-frequency coding. The encoders (405, 415) of FIG. 4D are preferably cyclic delay diversity (CDD) coders or cyclic shift diversity (CSD) coders. The output data streams of encoders (404, 405, 414, and 415) are subsequently applied to respective transmit antennas to advantageously provide spatial diversity as described with regard to the embodiment of FIG. 3E.

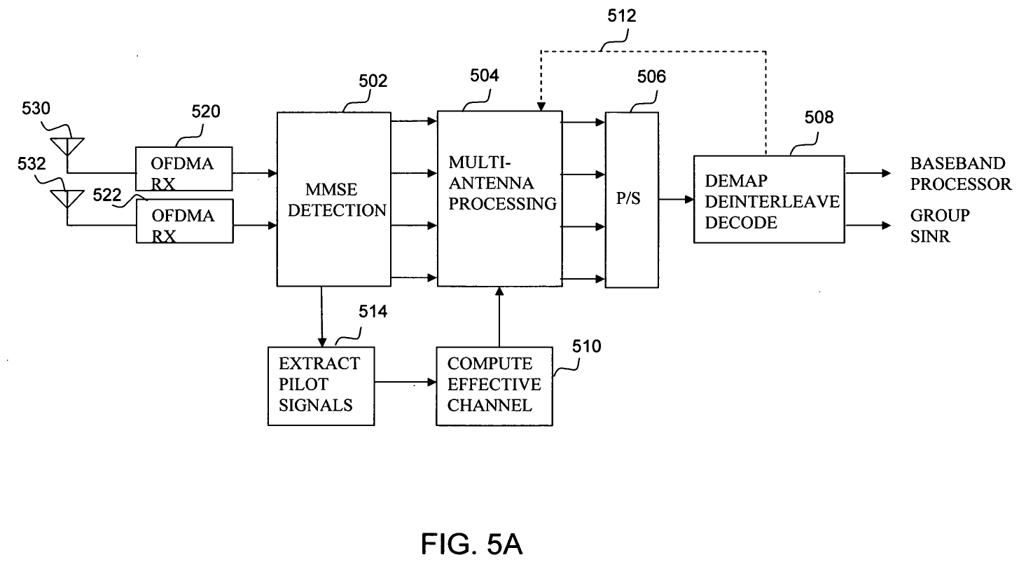

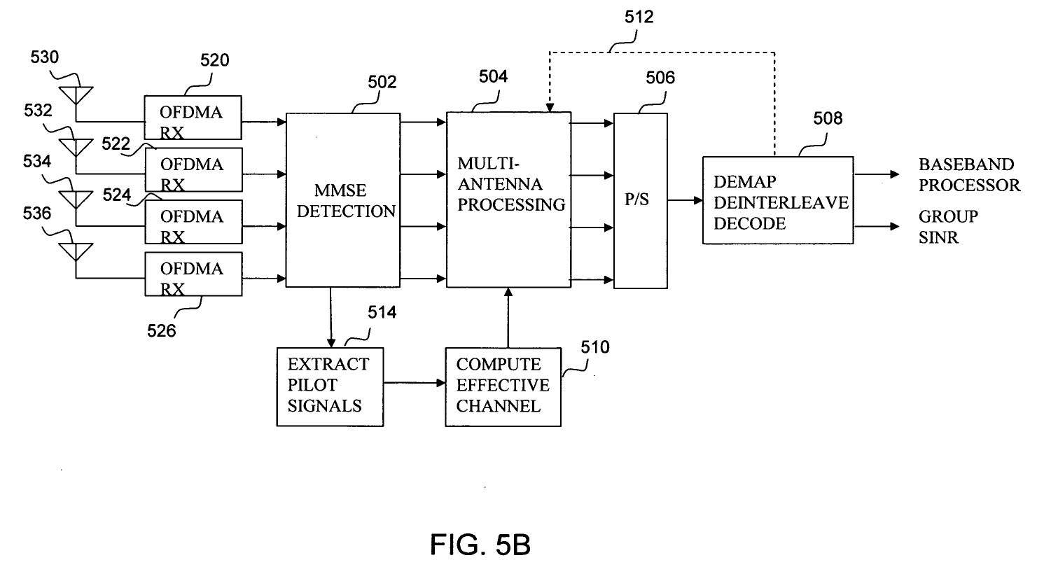

Referring to FIG. 5A, there is a simplified block diagram of a two antenna wireless receiver (UE) of the present invention. Inventive features of the previously described transmitters of the present invention are included in the receiver for compatibility. Antennas 530-532 receive signals from a remote transmitter. In a preferred embodiment, there are two, four, or more antennas 530-532. Received signals at each antenna 530-532 include first (S1) and second (S2) parts of the original data stream from transmit antennas of base stations 210-218 (FIG. 2). These received signals are applied to respective orthogonal frequency division multiple access (OFDMA) receiver circuits 520-522. The OFDMA circuits perform an FFT on each OFDM data stream to convert received signals to a stream of OFDM signals or tones in the frequency domain. The OFDM tones are applied to Mean Minimum Square Error (MMSE) detection circuit 502. The MMSE detection circuit detects user data streams from receive antennas 530-532. Alternative detection circuits utilizing match filter, zero forcing, or least square algorithms as are known in the art may also be used in lieu of MMSE detection. Furthermore, more advanced MIMO detection schemes such as decision feedback detection, serial interference cancellation (SIC) or maximum-likelihood (ML)-based detector can also be used. Circuit 514 extracts pilot signals from these user data streams. These pilot signals may have a power boost relative to data signals. The extracted pilot signals are applied to circuit 510 to compute an effective channel matrix representing the channel effect between the receiver and remote transmitter.

The outputs of the MMSE detection circuit 502 are applied to the multi-antenna processing circuit 504 and corrected by the effective channel matrix from circuit 510. The multi-antenna processing circuit 504 combines the first parts (S1) of the original data stream from each base station. The second parts (S2) of the original data stream from each base station are separately combined. The data stream is then reconstructed from the first (S1) and second (S2) parts. Different types of multi-antenna processing can be used such as linear, decision feedback, or maximum likelihood. These signals are subsequently converted to a serial data stream by parallel-to-serial converter 506. The serial data stream is then demapped, deinterleaved, and, decoded in circuit 508 and applied to a baseband processor (not shown). An optional feedback loop 512 from circuit 508 to circuit 504 allows a decision feedback operation which can improve the estimation of data bits. The decision feedback operation may include successive interference cancellation (SIC) wherein each detected signal is successively removed from the composite received signal. Circuit 508 also calculates a group SINR from the received signal which may be subsequently retransmitted to the remote transmitter as a CQI. The group SINR corresponds to a particular transmitter MCS that produced the intended user signal.

Referring to FIG. 5B, there is a simplified block diagram of a four antenna wireless receiver (UE) of the present invention. The embodiment of FIG. 5B differs from the previously described embodiment of FIG. 5A in that 4 receive antennas 530-536 receive first (S1) and second (S2) parts of the original data stream from transmit antennas of base stations 210-218 (FIG. 2). These received signals are applied to respective orthogonal frequency division multiple access (OFDMA) receiver circuits 520-526. The OFDMA circuits perform an FFT on each OFDM data stream to convert received signals to a stream of OFDM signals or tones in the frequency domain. The OFDM tones are applied to Mean Minimum Square Error (MMSE) detection circuit 502. MMSE detection circuit detects user data streams from receive antennas 530-536. The multi-antenna processing circuit 504 combines the first parts (S1) of the original data stream from each base station. The second parts (S2) of the original data stream from each base station are separately combined. The data stream is then reconstructed from the first (S1) and second (S2) parts. These signals are subsequently converted to a serial data stream by parallel-to-serial converter 506. The serial data stream is then demapped, deinterleaved, and, decoded in circuit 508 and applied to a baseband processor (not shown).

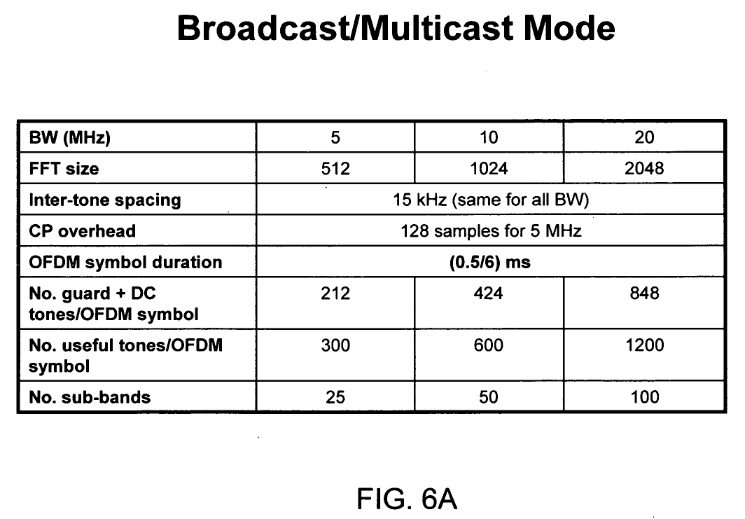

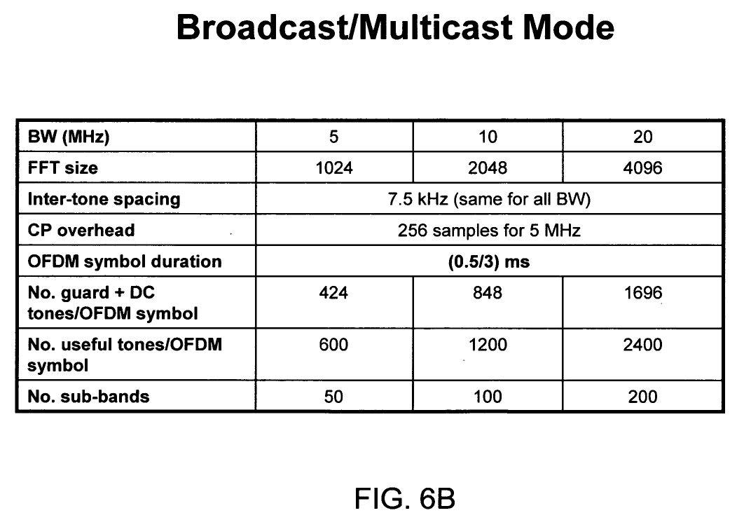

Referring now to FIGS. 6A and 6B, there is a table showing two exemplary numerology sets for the Broadcast/Multicast transmission structure of the present invention for 5, 10, and 20 MHz bandwidths (BW). For example, the 5 MHz bandwidth requires a Fast Fourier Transform (FFT) size of 512 samples. All bandwidths have an inter-tone spacing of 15 KHz. The cyclic prefix overhead requires 128 samples. In the second example (FIG. 6B), a longer cyclic prefix is used to accommodate applications with a longer channel.

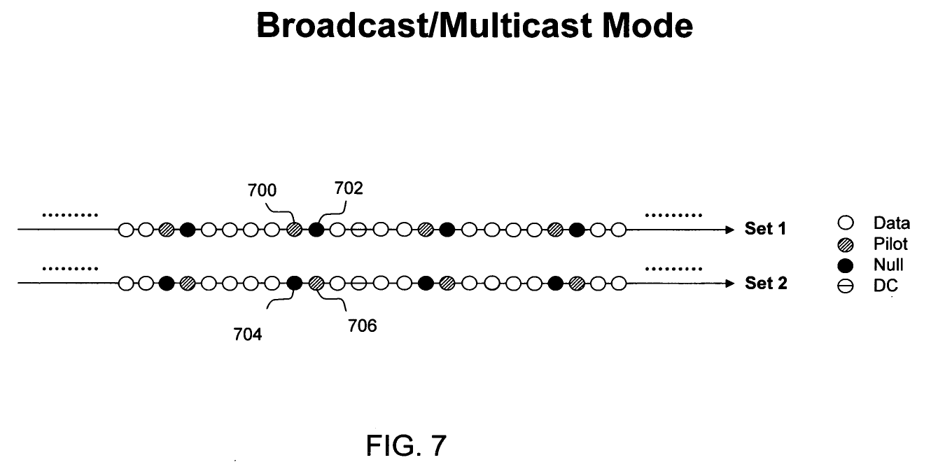

FIG. 7 illustrates two sets of OFDM symbols having guard tones, DC tones, pilot tones, and data. Set 1 represents a first part (S1) of a data stream as previously described. Set 2 represents a second part (S2) of the data stream. Pilot tones of each set correspond to null tones of the other set so that the first (S1) and second (S2) parts of the original data stream may be readily identified. For example, pilot tone 700 of set 1 is transmitted synchronously with null tone 704 of set 2. Likewise, null tone 702 of set 1 is transmitted synchronously with pilot tone 706 of set 2.

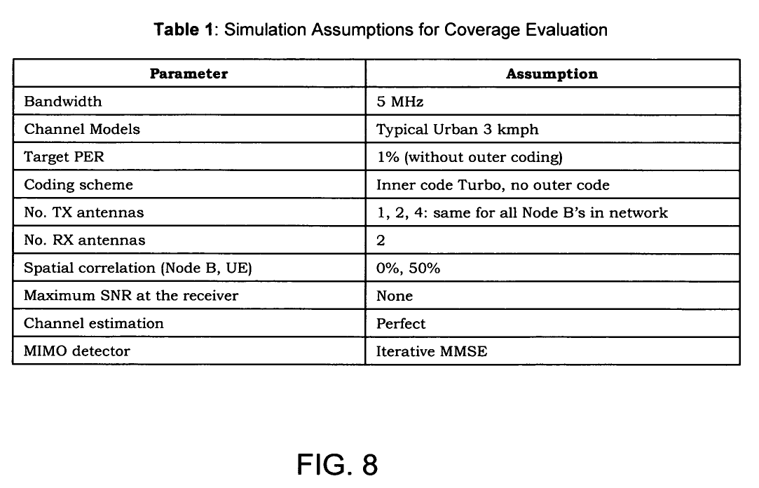

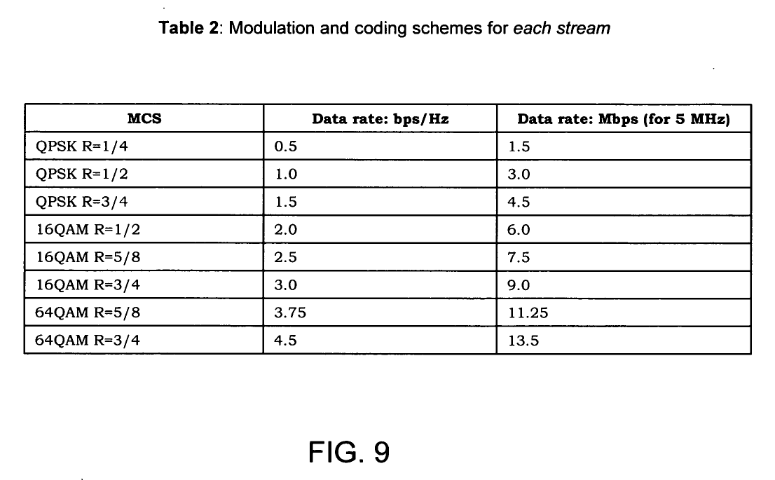

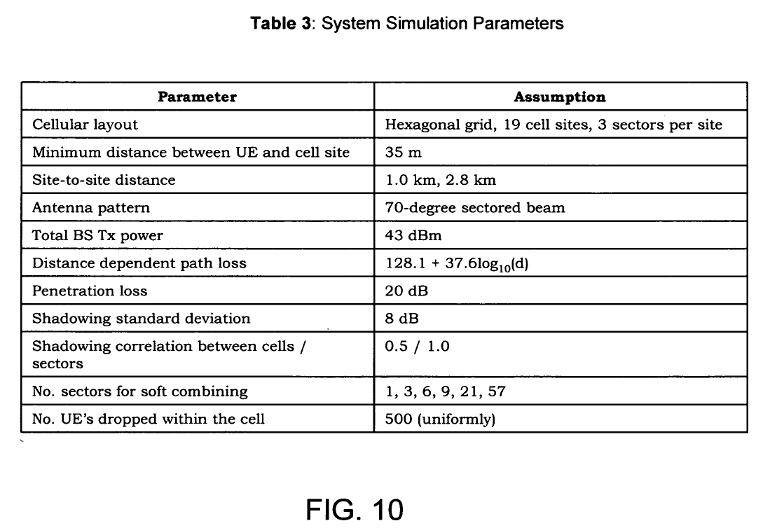

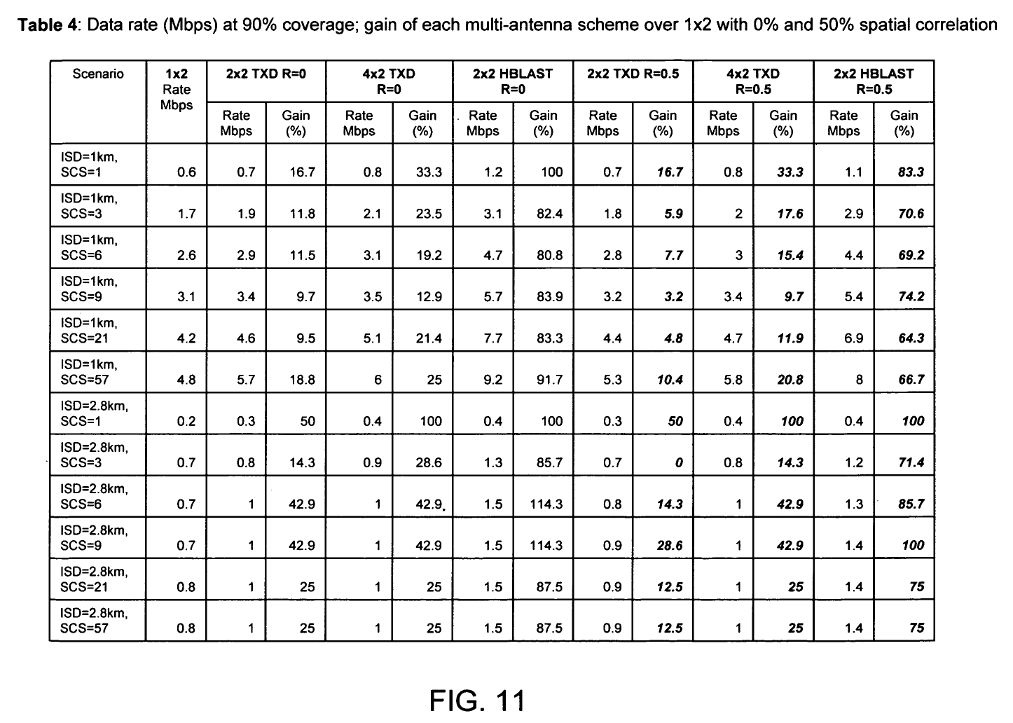

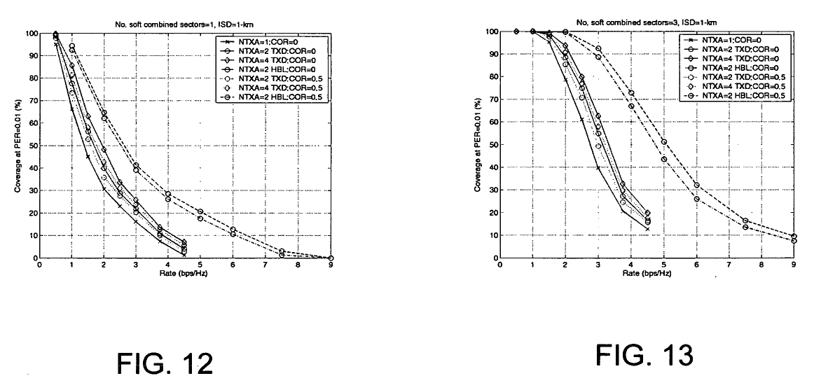

FIGS. 8-11 provide detailed information related to the simulations of FIGS. 12-23. In particular, FIG. 8 is a table of simulation assumptions. FIG. 9 is a table of modulation coding schemes. FIG. 10 is a table of simulation parameters. FIG. 11 is a table of simulated gain of multi-antenna schemes over single antenna transmission. The rows of FIG. 11 correspond respectively to the simulations of FIGS. 12 through 23. The rate columns of FIG. 11 correspond to the legend of respective simulation figures. Each of simulation FIGS. 12 through 23 plot coverage at a packet error rate (PER) of 1% for a corresponding transmission rate in bits-per-second per cycle (bps/Hz). For these simulations, coverage is the percentage of UEs that achieve packet error rates lower than 1% or 0.01. Rate and gain entries of FIG. 11 are taken at 90% coverage with 0% (COR=0) and 50% (COR=0.5) correlations. For example, the 1×2 column shows the rate for one transmit antenna and two receive antennas when 90% of UEs have a packet error rate of less than 1%. The first 2×2 TXD R=0 column shows the rate for two transmit antennas and two receive antennas with open loop transmit diversity when 90% of UEs have a packet error rate of less than 1% and 0% spatial correlation. The first 4×2 TXD R=0 column shows the rate for four transmit antennas and two receive antennas with open loop transmit diversity. The first 2×2 HBLAST R=0 column shows the rate for two transmit antennas and two receive antennas with HBLAST architecture.

Referring now to FIGS. 12-17, there are simulations of the present invention for 1 km separation of transmitters of adjacent cells for 1, 3, 6, 9, 21, and 57 soft combined sectors. Each of the simulations shows that the greatest coverage at all data rates is achieved by 2×2 HBLAST at 0 correlation and 2×2 HBLAST at 50% correlation. Furthermore, the simulations show that 9 soft combined sectors offer some improvement over 6 soft combined sectors. However, there is little further improvement with 21 or 57 soft combined sectors.

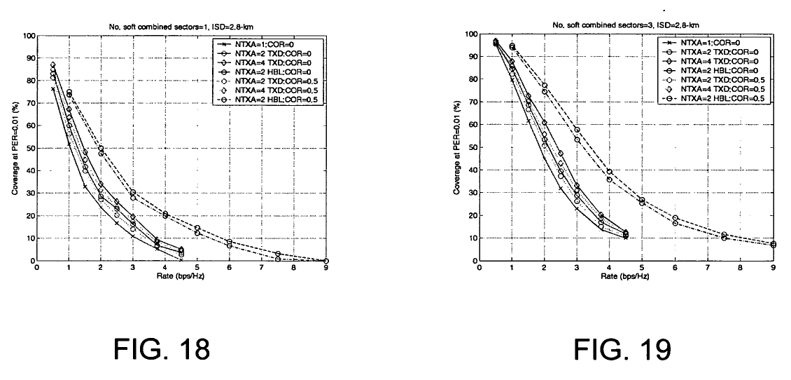

Turning now to FIGS. 18-23, there are simulations of the present invention corresponding to FIGS. 12-17 for 2.8 km separation of transmitters of adjacent cells. Here, the simulations again show that the greatest coverage at all data rates is achieved by 2×2 HBLAST at 0 correlation and 2×2 HBLAST at 50% correlation. These simulations also show that 6 to 9 soft combined sectors are near optimal. There is little further improvement with 21 or 57 soft combined sectors.

Still further, while numerous examples have thus been provided, one skilled in the art should recognize that various modifications, substitutions, or alterations may be made to the described embodiments while still falling with the inventive scope as defined by the following claims. For example, the present invention may be applied to any number of antennas greater than four. Although specific examples of Broadcast/Multicast transmission over 5, 10, and 20 MHz are presented, embodiments of the present invention are equally applicable to 1.25, 2.5, 15 MHz, or other bandwidths. Although an exemplary transmit time interval (TTI) of three or six OFDM symbols was discussed, any arbitrary number of OFDM symbols or TTI size may utilize inventive features of the present invention. While orthogonal frequency division multiplex (OFDM) transmission is presented as a preferred embodiment, CDMA might also be used with content-dependent spreading so that the same signal is transmitted from multiple base stations for a particular Broadcast/Multicast data stream. Furthermore, it is also possible to utilize some type of slow feedback to adapt the MIMO transmission schemes depending on the channel scenarios. Other combinations will be readily apparent to one of ordinary skill in the art having access to the instant specification.

What is claimed is:

1. A method of transmitting a wireless signal, comprising the steps of:
receiving a first data stream at a first transmitter;
receiving the first data stream at a second transmitter remote from the first transmitter;
transmitting a first part of the data stream from the first transmitter to a remote receiver; and
transmitting a second part of the data stream from the second transmitter to the remote receiver and not transmitting the first part of the data stream from the second transmitter to the remote receiver.

2. A method as in claim 1, wherein the first part and the second part of the data stream are derived from the same transmission content.

3. A method as in claim 1, wherein the first part of the data stream comprises a base layer content, and the second part of the data stream comprises an enhanced layer or a side content.

4. A method as in claim 1, wherein the first part of the data stream and the second part of the data stream originate from different content sources.

5. A method as in claim 1, wherein the first part of the data stream is transmitted from two transmit antennas, and the second part of the data stream is transmitted from a single transmit antenna.

6. A method as in claim 5, wherein the first part is transmitted from each transmit antenna at a lower power than the transmit power at the single transmit antenna.

7. A method as in claim 1, wherein each of the first and second parts comprise null tones and pilot tones, and wherein null tones of the first part are transmitted at frequencies where pilot tones of the second part are transmitted.

8. A method as in claim 1, wherein the first transmitter comprises a HBLAST architecture.

9. A method as in claim 8, wherein the first transmitter is augmented with a space-time, space-frequency, or space-time-frequency processing.

10. A method as in claim 1, wherein the first transmitter comprises a VBLAST architecture.

11. A method as in claim 10, wherein the first transmitter is augmented with a space-time, space-frequency, or space-time-frequency processing.

12. A method as in claim 1, wherein the first transmitter comprises a cyclic delay diversity (CDD) or cyclic shift diversity (CSD) architecture.

13. A method of receiving a wireless signal, comprising the steps of:
receiving a first part of a data stream from a first transmitter;
receiving a second part of the data stream and not the first part of the data stream from a second transmitter, the second transmitter being remote from the first transmitter; and
combining the first part and the second part to produce the data stream.

14. A method as in claim 13, wherein the first part of the data stream is transmitted from two transmit antennas, and the second part of the data stream is transmitted from a single transmit antenna.

15. A method as in claim 14, wherein the first part is transmitted from each transmit antenna at a lower power than the transmit power at the single transmit antenna.

16. A method as in claim 13, wherein each of the first and second parts comprise null tones and pilot tones, and wherein null tones of the first part are transmitted at frequencies where pilot tones of the second part are transmitted.

17. A method as in claim 13, wherein the first transmitter comprises a HBLAST architecture.

18. A method as in claim 17, wherein the first transmitter is augmented with a space-time, space-frequency, or space-time-frequency processing.

19. A method as in claim 13, wherein the first transmitter comprises a VBLAST architecture.

20. A method as in claim 19, wherein the first transmitter is augmented with a space-time, space-frequency, or space-time-frequency processing.

21. A method as in claim 13, wherein the first transmitter comprises a cyclic delay diversity (CDD) or cyclic shift diversity (CSD) architecture.

22. A method as in claim 13, wherein the step of receiving a plurality of signals comprises receiving a plurality of signals at a plurality of receive antennas.

23. A method as in claim 13, wherein the first part and the second part of the data stream are derived from the same transmission content.

24. A method as in claim 13, wherein the first part of the data stream comprises a base layer content, and the second part of the data stream comprises an enhanced layer or a side content.

25. A method as in claim 13, wherein the first part of the data stream and the second part of the data stream originate from different content sources.

26. A method of transmitting a wireless signal, comprising the steps of:
receiving a first data stream at a first transmitter;
receiving the first data stream at a second transmitter remote from the first transmitter;
transmitting a first part of the data stream from the first transmitter to a remote receiver; and
transmitting a second part of the data stream from the second transmitter to the remote receiver, wherein at least one of the steps of transmitting a first part and transmitting a second part includes transmitting with multiple antennas.

27. A method as in claim 26, wherein the first part and the second part of the data stream are derived from the same transmission content.

28. A method as in claim 26, wherein the first part of the data stream comprises a base layer content, and the second part of the data stream comprises an enhanced layer or a side content.

29. A method as in claim 26, wherein the first part of the data stream and the second part of the data stream originate from different content sources.

30. A method as in claim 26, wherein the first part of the data stream is transmitted from two transmit antennas, and the second part of the data stream is transmitted from a single transmit antenna.

31. A method as in claim 30, wherein the first part is transmitted from each transmit antenna at a lower power than the transmit power at the single transmit antenna.

32. A method as in claim 26, wherein each of the first and second parts comprise null tones and pilot tones, and wherein null tones of the first part are transmitted at frequencies where pilot tones of the second part are transmitted.

33. A method as in claim 26, wherein the first transmitter comprises a HBLAST architecture.

34. A method as in claim 33, wherein the first transmitter is augmented with a space-time, space-frequency, or space-time-frequency processing.

35. A method as in claim 26, wherein the first transmitter comprises a VBLAST architecture.

36. A method as in claim 35, wherein the first transmitter is augmented with a space-time, space-frequency, or space-time-frequency processing.

37. A method as in claim 26, wherein the first transmitter comprises a cyclic delay diversity (CDD) or cyclic shift diversity (CSD) architecture.

38. A method of receiving a wireless signal, comprising the steps of:
receiving a first part of a data stream from a first transmitter;
receiving a second part of the data stream, the second transmitter being remote from the first transmitter; and
combining the first part and the second part to produce the data stream, wherein at least one of the steps of receiving a first part and receiving a second part includes receiving from multiple antennas of one of the first and second transmitters.

39. A method as in claim 38, wherein the first part of the data stream is transmitted from two transmit antennas, and the second part of the data stream is transmitted from a single transmit antenna.

40. A method as in claim 39, wherein the first part is transmitted from each transmit antenna at a lower power than the transmit power at the single transmit antenna.

41. A method as in claim 38, wherein each of the first and second parts comprise null tones and pilot tones, and wherein null tones of the first part are transmitted at frequencies where pilot tones of the second part are transmitted.

42. A method as in claim 38, wherein the first transmitter comprises a HBLAST architecture.

43. A method as in claim 42, wherein the first transmitter is augmented with a space-time, space-frequency, or space-time-frequency processing.

44. A method as in claim 38, wherein the first transmitter comprises a VBLAST architecture.

45. A method as in claim 44, wherein the first transmitter is augmented with a space-time, space-frequency, or space-time-frequency processing.

46. A method as in claim 38, wherein the first transmitter comprises a cyclic delay diversity (CDD) or cyclic shift diversity (CSD) architecture.

47. A method as in claim 38, wherein the step of receiving a plurality of signals comprises receiving a plurality of signals at a plurality of receive antennas.

48. A method as in claim 38, wherein the first part and the second part of the data stream are derived from the same transmission content.

49. A method as in claim 38, wherein the first part of the data stream comprises a base layer content, and the second part of the data stream comprises an enhanced layer or a side content.

50. A method as in claim 38, wherein the first part of the data stream and the second part of the data stream originate from different content sources.
